(19) United States
(12) Patent Application Publication
(10) Pub. No.: US 2023/0296137 A1
(43) Pub. Date: Sep. 21, 2023

(54) Assembled Shaft and Method for Manufacturing an Assembled Shaft

(71) Applicant: Anton Häring KG, Bubsheim (DE)

(72) Inventor: Jürgen Häring, Bubsheim (DE)

(21) Appl. No.: 18/123,487

(22) Filed: Mar. 20, 2023

(30) Foreign Application Priority Data
Mar. 21, 2022 (EP) EP22163397.7

(51) Int. Cl. F16D 1/068; F16D 1/094; H02K 7/00

(52) U.S. Cl. CPC F16D 1/068; F16D 1/094; H02K 7/003; H02K 7/006; F16D 2300/12

(57) ABSTRACT

The invention discloses a method of manufacturing an assembled shaft, comprising the following steps:
at least one of a step of expanding the inner diameter of at least a joining portion of a first shaft element and a step of reducing the outer diameter of at least a joining portion of a second shaft element;
positioning the joining portion of the first shaft element around the joining portion of the second shaft element;
welding the first shaft element and the second shaft element by forcing a current flow through the first shaft element and the second shaft element; and
at least one of a step of reducing the inner diameter of at least the joining portion of the first shaft element and a step of increasing the outer diameter of at least the joining portion of the second shaft element.

### CROSS-REFERENCE TO RELATED APPLICATION(S)

This application claims the benefit of European Patent Application No. EP22163397.7, filed Mar. 21, 2022, the entirety of which is hereby incorporated herein by reference.

### BACKGROUND OF THE INVENTION

### 1. Field of the Invention

The present invention relates to an assembled shaft and particularly to a shaft-hub connection which is used in various applications. Instead of a solid shaft, a hollow shaft is used which may be installed in electric motors as the carrier shaft of the rotor package, such as in an electric motor of an electric vehicle.

A rotor shaft comprises various parts, which are characterized by different requirements. On the one hand, the requirements result from the end parts, which are usually designed as bearing points and are therefore often heat treated and ground, or finished, and on the other hand from a central part, to which the rotor pack is applied via various methods. The rotor assembly may be pressed onto a very precise, usually ground shaft. It is advantageous if this central part is hollow or comprises bores, through which a cooling medium may flow, which can cool the rotor pack during operation. The end pieces at each end of the shaft may have teeth or other form-locking elements, which are hardened or soft, which transmit or recuperate the torque generated by the rotation of the rotor pack in the stator to the gearbox or other assemblies connected to it.

The individual components of the assembled shaft are more or less stressed depending on the load scenario. In particular, the side acting directly on the gearbox is characterized by a static and dynamically acting torsional force, which acts on the shaft-hub connection of the various components of the rotor shaft.

The resulting misalignment of the individual acting elements to each other and the geometric misalignment resulting from the bearing on both sides cause bending stresses, which can also be described as rotating bending stress. These are speed-dependent in terms of the number of load reversals and load cycles and are equivalent in magnitude to the geometric misalignment and also the nominal load height at the respective load time.

The advantages of an assembled rotor shaft composed of shaft members are evident. On the one hand, the individual shaft elements of an assembled shaft may be optimized in terms of weight and load, and may be designed by the smallest possible hollow body. Thereby, a reduction in weight may be achieved. Because the individual shaft elements are smaller, a simpler, more cost-effective production process may be realized in large scale production by use of forming processes such as cold extrusion, semi-hot or hot extrusion. The material composition of the individual shaft members may be selected depending on the stress, i.e. high-quality, high-alloy material can be selected for the bearing points, but lower-quality materials may be used for the other areas having lower mechanical stress.

Further, the input weights for the heat treatment or other treatments of the shaft members are significantly lower as compared to an entire shaft, which leads to a constant quality and also to a more cost-effective utilization of the manufacturing equipment.

### 2. Description of the Related Art

It is known to build camshafts from several hollow bodies by capacitor discharge welding. It is also known to build a turbocharger by capacitor discharge welding of a hollow shaft with a turbine wheel, which also comprises hollow cross sections.

DE 10 2014 202 929 A1 discloses a wheel bearing hub and a flange which are joined to each other in a substance-to-substance bond, for example by impulse welding.

EP 372 663 B1 discloses pressure welding of a rotationally symmetrical metallic body on a metallic shaft. Capacitor discharge welding can be used as pressure welding.

WO 2009/052885 discloses the joining of a turbine wheel and a shaft of an exhaust gas turbocharger by capacitor discharge welding.

The prior art does not offer a technique for manufacturing an assembled shaft that fulfills the requirements for an electric motor vehicle.

### SUMMARY OF THE INVENTION

It is an object of the present invention to provide an assembled shaft and a method of manufacturing an assembled shaft, wherein the assembled shaft can fulfill the requirements of an electric motor, particularly an electric motor in an electric vehicle.

The object of the present invention is achieved by a method according to claim 1 and an assembled shaft according to claim 12.

The present invention discloses a method of manufacturing an assembled shaft comprising the step of expanding the inner diameter of at least a joining portion of a first shaft element and/or a step of reducing the outer diameter of at least a joining portion of a second shaft element. The method comprises the step of positioning the joining portion of the first shaft element around the joining portion of the second shaft element. The method further comprises the step of welding the first shaft element and the second shaft element by forcing a current flow through the first shaft element and the second shaft element.

The method comprises the step of reducing the inner diameter of at least the joining portion of the first shaft element and/or the step of increasing the outer diameter of at least the joining portion of the second shaft element.

Thereby, the first shaft element and the second shaft element are pressed and welded. It is to be understood, that an assembled shaft may comprise more than two shaft elements that are joined to each other to form the assembled shaft.

The method may comprise the step of arranging a flexible element between the joining portion of the first shaft element and the joining portion of the second shaft element. The flexible element may act as a centering element that centers the first shaft element with respect to the second shaft element before the step of welding the first shaft element and the second shaft element. The method may further comprise the step of forming a circumferential recess in the second shaft element and the step of positioning the flexible element in the circumferential recess. The flexible element may protrude from the circumferential recess.

The elastic element may be made of plastics, a peek polymer, polyethylene, rubber like material, non-ferreous metal, low-allow metals or the like.

The inventors of the present invention have recognized that by the pressing and welding technology described herein high load requirements at low cost may be met. The welded joint of the first and second shaft member, preferably made by capacitor discharge welding as a low-cost, high-quality welded j oint, is overlaid by a press fit such that it is not only capable of absorbing said torsional forces of a static and dynamic nature, but also of absorbing static and dynamic alternating bending stresses as well as bending circumferential stresses via the press fit. This represents a significant cost reduction compared with the laser welding processes commonly used today, which are very cost-intensive and do not exhibit the same behavior under continuous load.

When designing a shaft-hub connection, it is crucial to offer the possibility of dimensioning an explicit solution for the load spectrum required by the application. The weld seam may be designed radially as multiple protrusions, such that even very high torsional forces >1000 Nm may act, as well as via the press fit, which can be dimensioned accordingly in the axial direction for the various bending stresses >300 Nm so that no negative effects on the shaft-hub connection result over the service life. This ensures the robustness of the overall system and the press fit can be used in a wide variety of applications.

The method may further comprise the step of forming a protrusion on the first shaft element that is directed to the second shaft element. Additionally or alternatively the method may comprise the step of forming a protrusion on the second shaft element that is directed to the first shaft element. Then, the method comprises the step of welding the first shaft element and the second shaft element by melting the protrusion by a current flow. The protrusion generates a region of low electrical resistance in which the current flows. The protrusion melts and seals the gap between the joining portion of the first shaft element and the joining portion of the second shaft element against corrosion and generates a mechanically stable connection..

The method further comprises the step of forming the protrusion in the axial direction from the axial end face of the second shaft element toward the axial end face of the first shaft element.

The step of forming a protrusion on the first shaft element that is directed to the second shaft element and/or forming a protrusion on the second shaft element that is directed to the first shaft element comprises the step of forming a cone shaped protrusion. The cone shaped protrusion causes a high current density for melting the cone shaped protrusion and for quickly welding the first shaft element with the second shaft element. A plurality of protrusions may be arranged on the axial end face of the second shaft element, wherein the protrusions are positioned at a constant radius from the axis of the second shaft member. The protrusions melt during welding, such as capacitor discharge welding.

During the capacitor discharge welding process, an exact orientation of the components to be welded is important, because any deviation or eccentricity leads on the one hand to imbalance on the finished rotor shaft and on the other hand to increased machining or cutting effort. Therefore, during capacitor discharge welding, care is taken to use auxiliary devices to center the parts to be joined in the best possible way, ideally below approximately 0.1 mm. Then, the protrusions are melted such that in the very short period of capacitor discharge welding, the current discharges exactly at this point, where the lowest electrical resistance is located and contact is created between the two joining portions. When the current discharge causes a local heating of the weld protrusion, a melting of the material in the area of the protrusion within a few milliseconds is caused. In capacitor discharge welding, a permanently constant contact force acts in a superimposed manner in the axial direction of the shaft members, and thus the welded joint is formed in the shortest possible time during the melting process. This takes place without heating the parts to be welded, since the time span of the welding process is extremely short.

Outside the welding area, however, contact between the joining partners must be prevented.

A press fit requires narrow tolerances between the joining partners that are being pressed, i.e. the joining portion of the first shaft element and the joining portion of the second shaft element. The pressing is carried out forcibly via a mechanical contact. This results in a defined overlap of the joining portion of the first shaft element and the joining portion of the second shaft element joined to form the press fit. Depending on the dimensions and materials used, the press fit is designed to withstand the acting loads.

To combine both processes, the conventional, preferably axial capacitor discharge welded joint is performed first.

The joining portion of the first shaft element may be expanded such that the joining portion of the first shaft element and the joining portion of the second joining element can be pushed into each other with a minimum of radial play (less than 0.3 mm).

Expansion can be achieved by a wide variety of methods, on the one hand by the action of heat or other media, and on the other hand by mechanical, electromechanical or hydraulic action. In one embodiment, inductive heating of one of joining portion of the first shaft element results in an increase in the inner diameter of the joining portion.

Further, it is possible to reduce the effective diameter of the joining portion of the second shaft element. This may be achieved by supplying cold media, such as liquid nitrogen or by mechanical, electromechanical or hydraulic processes, which, for example, but not only by elongation in the axial direction, lead to a reduction in the diameter, which after subsequent relief relaxes to the original dimension, as long as this is within the elastic range of the material.

In both cases, capacitor discharge welding is possible on the contacting plane surfaces of the two joining portions, since at the time of welding the parts are not in contact in the radial direction. However, to properly dimension the clearance to the load requirement and not to the joining process, it is possible to additionally use an elastic element and joining aid, respectively.

The elastic element (joining aid) may be made of a material that is placed in the recess formed into one of the two joining partners (joining section of the first or second shaft element). During joining, the flexible element spaces the two joining portions apart in the axial direction from each other and thus prevents direct electric contact, and thus prevents any flow of electrical energy. During the formation of the press fit, i.e. when the two joining partners (joining portions of the first and second shaft element) are pressed together, the elastic element (joining aid) may retract into the respective recess. The recess is thus larger in volume than the volume of the elastic element. The elastic j oining aid (elastic element) may be deformed in such a way that it utilizes the available volume of an annular recess. The elastic joining aid may also have the effect of additionally fine centering, depending on how rigid it is made. This ultimately means that the imbalance induced via the shaft-hub connection is significantly lower than with a traditional capacitor welded connection.

For example, if the rotor shaft (in one embodiment the first shaft element) is thermally heated, then such heat generation can radiate to the welded portion and lead to slower cooling of the welded portion and thus to less crack formation and in the best case eliminate it completely.

If such heating is carried out at the same time as the expansion, energy optimization is possible in multiple ways. For example, residual heat from hardening a shaft member may be used for expanding the second shaft member and waste heat during final cooling has a tempering function for the next batch.

If the connection between the first and second shaft member is designed such that the melted material flows into the free spaces, then an airtight connection is created which, depending on the design, seals the desired areas, such as the joining section of the first and second shaft element. This sealing function ensures that crevice corrosion, which is always a latent threat, is reduced or completely eliminated. In this respect, a significant increase in the overall service life of the press-weld bond is ensured.

The method further comprises the step of forming an essentially cylindrical opening in the end face of the first shaft element extending in the axial direction of the first shaft element, wherein the essentially cylindrical opening in the end face of the first shaft element forms the joining portion of the first shaft element. The method further comprises the step of positioning the joining portion of the second shaft element in the essentially cylindrical opening in the end face of the first shaft element.

The step of expanding the inner diameter of at least the joining portion of the first shaft element comprises the step of heating at least the joining portion of the first shaft element. Thereby, fractures forming after capacitor discharge welding can be avoided. The method further comprises the step of reducing the inner diameter of at least the joining portion of the first shaft element comprising the step of cooling the joining portion of the first shaft element. The cooling must not be necessary a cooling by a cooling media. The cooling step may be performed by any type of forced or unforced cooling.

In one embodiment the first shaft element and/or the second shaft element may be a hollow shaft. Thereby, a cooling liquid may flow through the hollow shaft cooling element positioned on the hollow shaft.

The method may further comprise the step of arranging a rotor of an electric motor on the first shaft element and/or the second shaft element. The rotor bank can be cooled, if a coolant flows through a hollow shaft.

The step of welding the first shaft element and the second shaft element by forcing a current flow through the first shaft element and the second shaft element comprises a capacitor discharge welding. During this step the first shaft element and the second shaft element are pressed against each other.

The invention further discloses an assembled shaft manufactured by the above method steps.

The invention further discloses an assembled shaft comprising a first shaft element having a joining portion having an inner diameter. A second shaft element of the assembled shaft has a joining portion having an outer diameter, wherein the joining portion of the first shaft element is arranged around the joining portion of the second shaft element by press fit. The front face of the joining portion of the second shaft element is welded to the first shaft element.

The assembled shaft may be configured as described by the method above.

A flexible element is arranged between the joining portion of the first shaft element and the joining portion of the second shaft element, as described above.

The invention also discloses an electric motor comprising the assembled shaft manufactured according the above method steps or comprising the above assembled shaft. In this embodiment, the rotor element may be arranged on the first shaft element and/or the second stop shaft element.

The invention further discloses a vehicle comprising the assembled shaft manufactured according to the above described method steps or the electric motor having the assembled shaft manufactured according to the above described method steps.

In yet another aspect, the invention is

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

The invention is now explained in further detail with reference to the enclosed drawings depicting non-limiting and exemplary embodiments of the present invention, wherein:

FIG. 1 shows a sectional view of a joint of a first shaft member and a second shaft member;

FIG. 2 shows a magnified portion of FIG. 1, which is of particular interest;

FIG. 3a shows an assembled shaft manufactured from three shaft elements;

FIG. 3b shows an assembled shaft manufactured from three shaft elements;

FIG. 4 shows a portion of the second shaft element, in which recess are formed for accommodating an elastic element;

FIG. 5 shows the first shaft element and the second shaft element before welding; and

FIG. 6 shows the first shaft element and the second shaft element after welding and pressing the first shaft element on the second shaft element in a sectional and partially cut away view.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

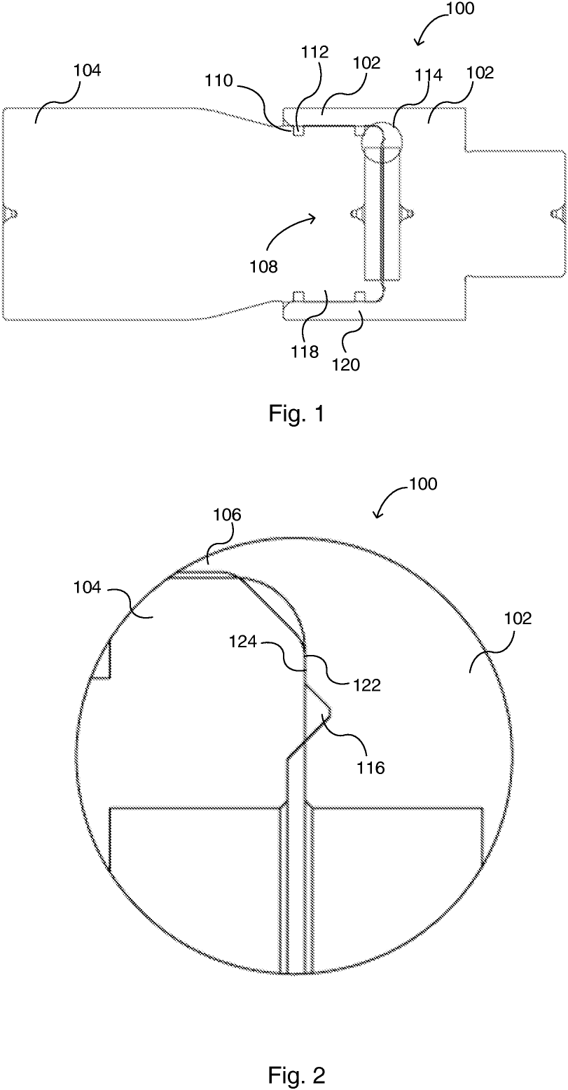

FIG. 1 shows a sectional view of a portion of an assembled shaft 100 comprising a first shaft element 102 and a second shaft element 104. The first shaft element 102 and the second shaft element 104 are essentially cylindrical. A joining portion 118 of the second shaft element 104 is positioned in a cylindrical opening 108 formed in the first shaft element 102. The cylindrical opening 108 extends essentially in the axial direction. A joining portion 106 of the first shaft member 102 extends along the opening 108 in the first shaft element 102 in axial direction and fixes the joining portion 118 of the second shaft element 104 in radial and axial direction. In other words, the joining portion 120 of the first shaft element 102 and the j oining portion 118 of the second shaft element 104 extend in axial direction.

FIG. 2 shows portion 114 of FIG. 1 in a magnified view. On the second shaft element 104 a protrusion, a cone 116 or the like is formed. In FIG. 2 the cone 116 is schematically shown to extend into the first shaft element. This is not the case after welding the first shaft element and the second shaft element 104. Before inserting the joining portion 118 of the second shaft element 104 into the axial opening 108 and the joining portion 120 of the first shaft element, the j oining portion 120 of the first shaft element is heated, such that the inner diameter of the j oining portion 120 of the first shaft element 102 is increased. The second shaft element 104 is moved into the axial opening 108 until the cone 116 touches the axial end face 122 of the first shaft element 102. Thus, an axial end face 124 of the second shaft element 104 is spaced apart from the axial end face 122 of the first shaft element 102.

Thereafter, the first shaft element 102 and the second shaft element 104 are pressed towards each other in the axial direction, and the current flow is forced through the first shaft element 102 and the second shaft element 104. The current flow can be generated by capacitor discharging. The current flows through the cone 116 and melts the cone 116 such that the melted material of the cone 116 seals the end face 122 of the first shaft element 102 and the end face 124 of the second shaft element 104 and fixes the end face 122 of the first shaft element 102 to the end face 124 of the second shaft element 104. Thereafter, the temperature of the joining portion 120 of the first shaft element 102 is reduced. Since the j oining portion 120 and the end face 122 of the first shaft element 102 have been heated before welding formation of cracks can be reduced significantly if not eliminated. After cooling the j oining portion 120 of the first shaft element the first shaft element 102 and the second shaft element 104 are fixed by welding at their respective end faces 122 and 124 as well as by a press fit generated by a protrusion 106 extending from the end face 122 in axial direction of the first shaft element 102 against the j oining portion 118 of the second shaft member 104. Capacitor discharge welding is known to the person skilled in the art and does not have to be explained in further detail herein.

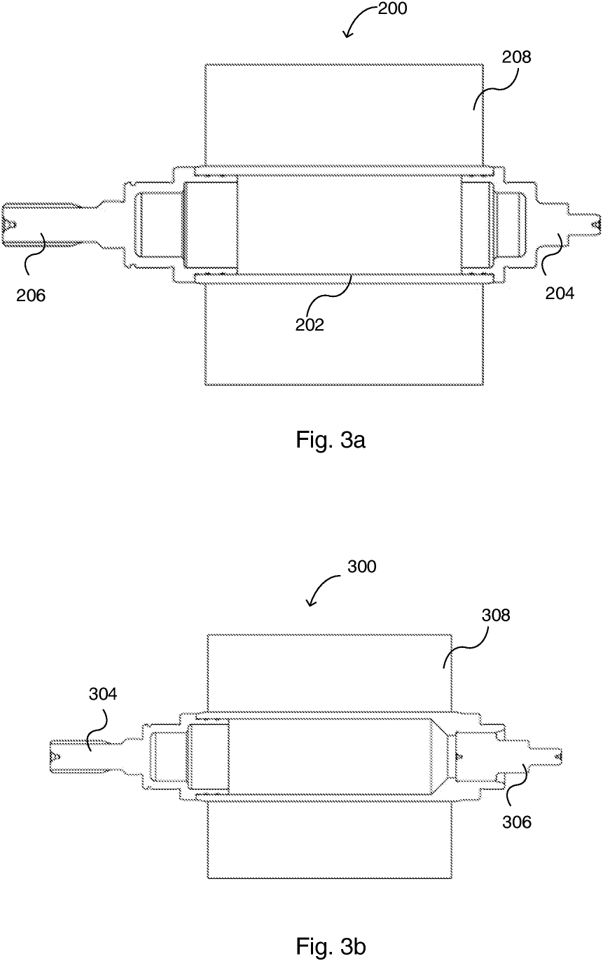

Reference is made to FIG. 3a showing an assembled shaft 200 having three shaft elements 202, 204 and 206. The shaft elements are fixed to each other as described herein by pressing and welding. The first shaft element 202 is a hollow shaft. The second shaft element 204 and the third shaft element 206 are partially hollow. On the first shaft element 202 the rotor 208 of an electric motor can be fixed. The second shaft element 204 and the third shaft element 206 may act as a hub.

FIG. 3b shows another embodiment of an assembled shaft 300 comprising three shaft elements 302, 304 and 306. On the first shaft element 300 to a rotor 308 of an electric motor may be arranged. The first shaft element 302 is hollow. The second shaft element 304 is partially hollow. The third shaft element 306 is solid. The first shaft element 302, the second shaft element 304 and the third shaft element 306 may be fixed as described herein by pressing and welding. The second shaft element 304 and the third shaft element 306 may act as a hub. The shaft elements may be made of steel. Shaft elements that face a high load may be made of high-alloy steel, tempered steel or hardened steel, and shaft elements that face a lower load may be made of low-allow steel.

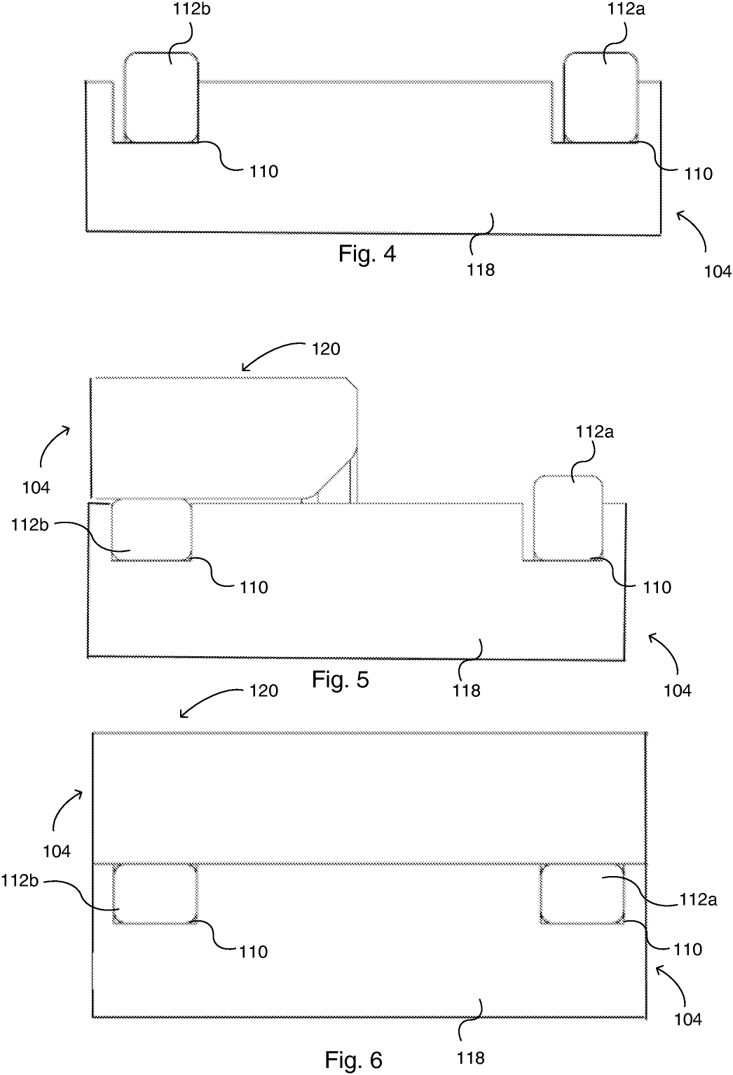

FIG. 4 shows the j oining portion 118 of the second shaft element 104 in a partially cut away view. In the second shaft element a circumferential recess 110 is formed. The circumferential recess 110 extends in the radial direction of the second shaft element 104 and extends around the perimeter of the second shaft element 104. Within the recess 110 an elastic element 112 is positioned.

Reference is made to FIG. 5 showing a sectional and partially cut away view of the first shaft element 102 and the second shaft element 104 during the process of joining the first shaft element 102 and the second shaft element 104. The protrusion 106 of the j oining portion 120 of the first shaft element is partially moved on the j oining portion 118 of the first shaft element, such that the elastic element 112b is compressed and the elastic element 112a is not compressed. Since the protrusion 106 comprises a larger diameter than the j oining portion 118 of the first shaft element 104, since the j oining portion 120 of the first shaft element 102 has been heated, the joining portion 120 of the first shaft element 102 is slightly spaced apart from the joining portion 104 of the first shaft element 118. The elastic elements 112a, 112b act to center and/or align the first shaft element 102 with respect to the second shaft element 104.

FIG. 6 shows a sectional and partially cut away view of the first shaft element 102 and the second shaft element 104 after cooling the protrusion 106 of the j oining portion 120 of the first shaft element. As shown in FIG. 6 the j oining portion 106 of the first shaft element and the j oining portion 110 of the second shaft element 104 abut each other to form a press fit and compresses the flexible elements 112a and 112b.

The elastic element 112a, 112b may be made of plastics, a peek polymer, polyethylene, rubber like material, non-ferreous metal, low-allow metals or the like.

The inventors of the present invention have recognized that by the pressing and the welding technology described herein high load requirements at low cost may be met. The welded joint of the shaft members is preferably made by capacitor discharge welding as a low-cost, high-quality welded joint and is overlaid with a press fit such that it is capable of absorbing high torsional forces of a static and dynamic nature and capable of absorbing static and dynamic alternating bending stresses as well as bending circumferential stresses via the press fit. This represents a significant cost reduction compared with the laser welding processes commonly used today, which are very cost-intensive and do not exhibit the same behavior under continuous load.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. §112(f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method of manufacturing an assembled shaft, comprising the following steps:
at least one of a step of expanding the inner diameter of at least a joining portion of a first shaft element and a step of reducing the outer diameter of at least a joining portion of a second shaft element;
positioning the joining portion of the first shaft element around the joining portion of the second shaft element;
welding the first shaft element and the second shaft element by forcing a current flow through the first shaft element and the second shaft element; and
at least one of a step of reducing the inner diameter of at least the joining portion of the first shaft element and a step of increasing the outer diameter of at least the joining portion of the second shaft element.

2. Method according to claim 1, further comprising the step of arranging a flexible element between the joining portion of the first shaft element and the joining portion of the second shaft element.

3. The method according to claim 2, further comprising the steps of
forming a circumferential recess in the second shaft element; and
positioning the flexible element in the circumferential recess.

4. The method according to claim 1, further comprising at least one of the following two steps:
forming a protrusion on the first shaft element that is directed to the second shaft element;
forming a protrusion on the second shaft element that is directed to the first shaft element; and
further comprising the following step:
welding the first shaft element and the second shaft element by melting the protrusion by the current flow.

5. The method according to claim 4, further comprising the step of forming the protrusion in the axial direction from the axial end face of the second shaft element toward the axial end face of the first shaft element.

6. The method according to claim 4, wherein the step of forming a protrusion on first shaft element that is directed to the second shaft element and/or forming a protrusion on second shaft element that is directed to the first shaft element comprises the step of forming a cone shaped protrusion.

7. The method according to claim 1, further comprising the steps of
forming an essentially cylindrical opening in the end face of the first shaft element extending in the axial direction of the first shaft element, wherein the essentially cylindrical opening in the end face of the first shaft element forms the joining portion of the first shaft element; and
positioning the joining portion of the second shaft element in the essentially cylindrical opening in the end face of the first shaft element.

8. The method according to claim 1, wherein
the step of expanding the inner diameter of at least the joining portion of the first shaft element comprises the step of heating at least the joining portion of the first shaft element; and
the step of reducing the inner diameter of at least the joining portion of the first shaft element comprises the step of cooling at least the joining portion of the first shaft element.

9. The method according to claim 1, wherein at least one of the first shaft element and second shaft element is a hollow shaft.

10. The method according to claim 1, further comprising the step of arranging a rotor of an electric motor on at least one of the first shaft element and the second shaft element.

11. The method according to claim 1, wherein the step of welding the first shaft element and second the second shaft element by forcing a current flow through the first shaft element and the second shaft element comprises a capacitor discharge welding.

12. An assembled shaft, comprising:
a first shaft element having a joining portion having an inner diameter;
a second shaft element having a joining portion having an outer diameter, wherein the joining portion of the first shaft element is arranged around the joining portion of the second shaft element by press fit;
characterized in that the front face of the joining portion of the second shaft element is welded to the first shaft element.

13. The assembled shaft according to claim 12, wherein a flexible element is arranged between the joining portion of the first shaft element and the joining portion of the second shaft element.

14. An electric motor, comprising the assembled shaft manufactured according the method steps according to claim 1, wherein a rotor is arranged on at least one of the first shaft element and second shaft element.

15. A vehicle having the assembled shaft according to claim 12.

16. An electric motor, comprising the assembled shaft according to claim 12, wherein a rotor is arranged on at least one of the first shaft element and second shaft element.

17. A vehicle having the electric motor according to claim 14.
